(19) United States
(12) Patent Application Publication
(10) Pub. No.: US 2007/0080551 A1
(43) Pub. Date: Apr. 12, 2007

(54) Tandem trailer lock release mechanism

(76) Inventor: Duane L. Fleck, Lacenter, WA (US)

Correspondence Address: LITMAN LAW OFFICES, LTD, PO BOX 15035, CRYSTAL CITY STATION, ARLINGTON, VA, 22215, US

(21) Appl. No.: 11/527,453

(22) Filed: Sep. 27, 2006

Related U.S. Application Data
(60) Provisional application No. 60/725,312, filed on Oct. 12, 2005.

(51) Int. Cl. B66C 1/34

(52) U.S. Cl. 294/82.16

(57) ABSTRACT

The tandem trailer lock release mechanism has an elongated inflexible rigid member having a proximal end and a distal end. A handgrip is provided at the distal end. A hook for engaging a locking pin release lever is provided at the proximal end. A release lever tensioner has opposing ends and is connected to a collar. The collar is slidably attached to the rigid member. The opposing ends of the release lever tensioner have one end closer to the proximal end of the rigid member, while the other end is closer to the distal end of the rigid member. The release lever tensioner also has an inverted L-shaped member for engaging a trailer side. A handlebar is included for pulling the tensioner. Pin-releasing tension is provided by a spring that is hooked onto the release lever tensioner and the proximal end of the rigid member.

### CROSS-REFERENCE TO RELATED APPLICATION

This application claims the benefit of U.S. Provisional Patent Application Ser. No. 60/725,312, filed Oct. 12, 2005.

### BACKGROUND OF THE INVENTION

1. Field of the Invention

The present invention relates to semitrailers, and more particularly to a tandem trailer lock release mechanism for releasing the pins locking a sliding frame above the tandem axles of semitrailers that is used to adjust the weight distribution of the trailer and cargo supported by the tandem axles.

2. Description of the Related Art

Truck semitrailers are equipped with a sliding frame, which is slid over a tandem axle assembly to adjust the position of the trailer to account for the weight distribution of the cargo inside the semitrailer. The tandem axles are mounted on a carriage assembly. A pair of parallel rails with sliding components is mounted on the bottom of the trailer above the tandem axles. The carriage is adapted to slide along the rails.

A series of uniformly spaced transverse holes are defined along each of the rails. Two pairs of spring-loaded pins, one pair toward the front of the tandem axle carriage and one toward the rear of the carriage, selectively engage the holes to lock the trailer and the tandem axle carriage together. A release handle is provided adjacent the tandem axle assembly to simultaneously release the pins in order to slide the tandem axle carriage on the rails.

However, due to the weights involved and the pressure of the spring-loaded pins, the pins have a tendency to become jammed. In order to better align the pins with the holes to free the release handle, the operator must use the tractor to rock the trailer back and forth. This can be done by one person alone, but requires considerable time and a great deal of trial and error. More often, two persons are required, one to rock the trailer, and a second person to apply pressure to the release handle during the rocking operation. However, since the release handle is close to the tandem axle assembly, there is a substantial safety risk to the person applying pressure to the release handle.

While several deices have been developed to alleviate this risk, none have proven to be entirely satisfactory.

Thus, a tandem trailer lock release mechanism solving the aforementioned problems is desired.

### SUMMARY OF THE INVENTION

The tandem trailer lock release mechanism comprises an elongated inflexible rigid member having a proximal end and a distal end. A handgrip is provided at the distal end. A hook for engaging a locking pin release lever is provided at the proximal end. A release lever tensioner has opposing ends and is connected to a collar. The collar is slidably attached to the rigid member. The opposing ends of the release lever tensioner have one end closer to the proximal end of the rigid member, while the other end is closer to the distal end of the rigid member. The release lever tensioner also has an inverted L-shaped member for engaging a trailer side. A handlebar is included for pulling the tensioner. Pin-releasing tension is provided by a spring that is hooked onto the release lever tensioner and the proximal end of the rigid member.

These and other features of the present invention will become readily apparent upon further review of the following specification and drawings.

### BRIEF DESCRIPTION OF THE DRAWINGS

FIG. 1 is an environmental, perspective view of a tandem trailer lock release mechanism according to the present invention.

FIG. 2 is a perspective view of the tandem trailer lock release mechanism according to the present invention.

FIG. 3 is a side view of the tandem trailer lock release mechanism according to the present invention.

Similar reference characters denote corresponding features consistently throughout the attached drawings.

### DETAILED DESCRIPTION OF THE PREFERRED EMBODIMENT

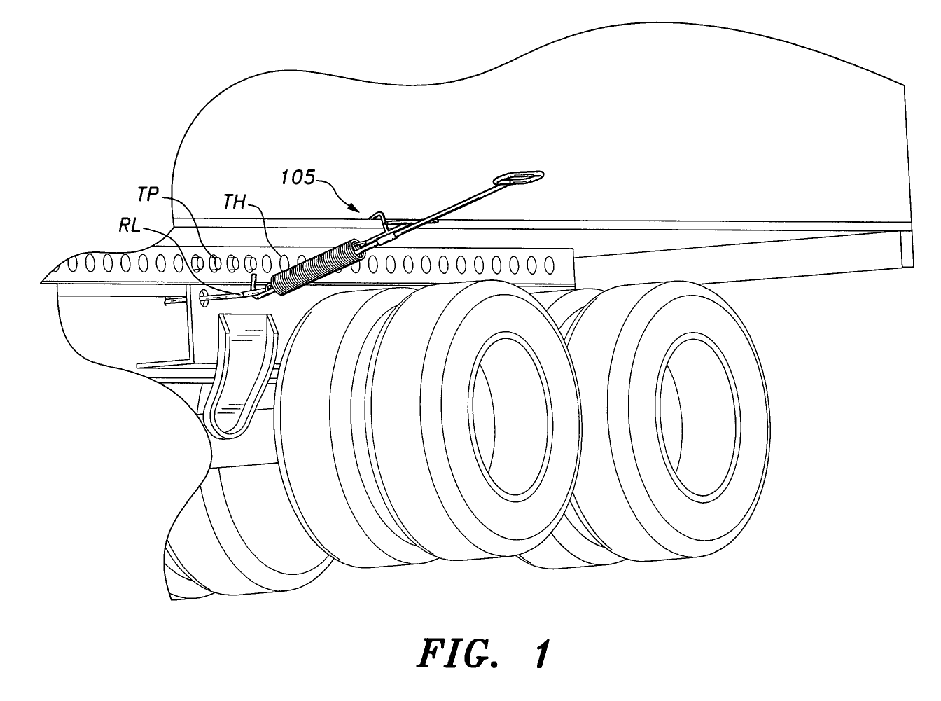

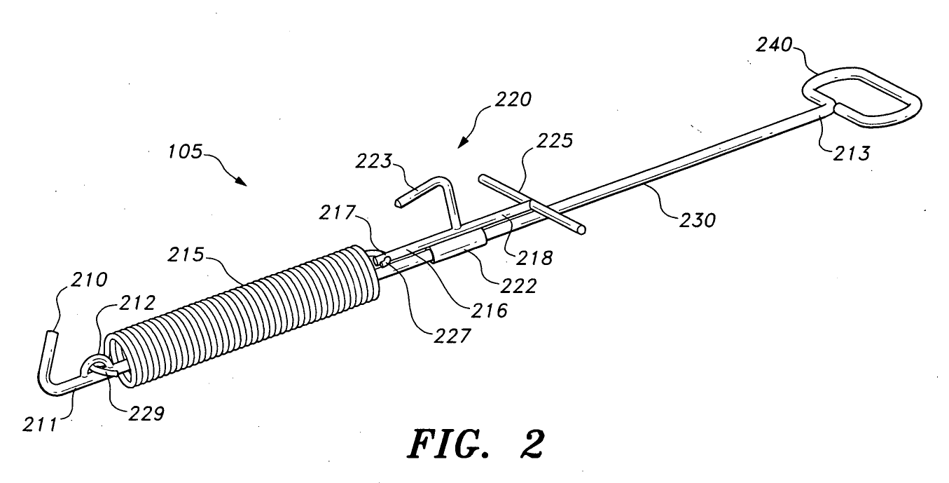

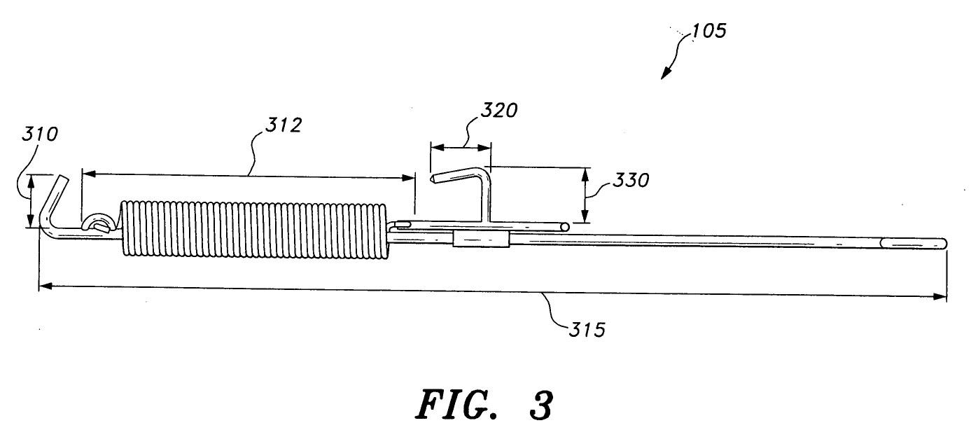

As shown in the FIGS. 1-3, the tandem trailer lock release mechanism 105 comprises an elongated rigid member 230 having a proximal end 211 and a distal end 213. Preferably, end-to-end length 315 of the rigid member 230 is approximately 32½ inches. An oval-shaped handle or handgrip 240 is provided at the distal end 213.

A hook-shaped release lever engaging tang 210, preferably extending a distance 310 of approximately two inches from the rigid member 230, for engaging a locking pin release lever RL is provided at the proximal end 211. A release lever tensioner 220 has opposing ends 216, 218 and is fixed to a collar 222. The collar 222 is slidably attached to the rigid member 230.

The opposing ends of the release lever tensioner 220 comprise a first end 216 closer to the proximal end 211 of the rigid member 230, while the second end 218 is closer to the distal end 213 of the rigid member 230. The release lever tensioner 220 also has an inverted L shaped member 223 for engaging a trailer side. Inverted L shaped member 223 has substantially orthogonal components extending a distance 330 approximately two inches normal to the rigid member 230 and a distance 320 approximately two inches parallel to rigid member 230.

A T-handle 225 is attached at the second end 218 of tensioner 220 for pulling the tensioner 220. Pin-releasing tension is provided by a tension spring 215 having a first spring hook end 227 attached to the first end 216 of the release lever tensioner 220 at release lever tensioner spring connection point 217.

Release lever tensioner spring connection point 217 may be, for example, a hole in the first end 216 of the release lever tensioner 220, through which the first end 227 of spring 215 is fitted. Spring 215 also has a second end 229 attached to the proximal end 211 of the rigid member 230 at rigid member spring connection point 212.

Spring connection point 212 may be a loop that is welded to, formed from, or otherwise attached to rigid member proximal end 211 for receiving the second end 229 of spring 215. End-to-end distance of the spring 312 in a non-extended state is approximately one foot. Preferably spring 215 has an initial tension of thirty-two pounds and a force multiplier of 13.5 lbs per inch of displacement.

A user of the release mechanism 105 may pull the release lever RL to retract tandem pins TP by engaging the release lever RL with the release lever engaging tang 210 and, while grasping the handgrip 240, pulling the device 105 in a direction away from the release lever RL.

If the release lever RL fails to retract the pins TP, then the user may use the release lever tensioner 220 by pulling on the handlebar 225 in a direction away from the release lever while the release lever engaging tang 210 is still engaged with the release lever RL. The user continues pulling the handlebar 225 until the user can engage the inverted L-shaped engaging member 223 with a side of the trailer. This procedure applies a spring-multiplied, steady state force on the release lever RL. If the pins TP still have not retracted, the user rocks the trailer by attempting to drive the trailer with the trailer brakes on and with the mechanism 105 still engaging release lever RL and side of trailer. The rocking procedure aligns tandem holes TH with pins TP, thus allowing device 105 to successfully pull the release lever RL. The user may then get out of the truck, lock the release lever RL in a pin retracted mode, remove the mechanism 105, and adjust the tandem position as desired.

It is to be understood that the present invention is not limited to the embodiment described above, but encompasses any and all embodiments within the scope of the following claims.

I claim:

1. A tandem trailer lock release mechanism, comprising:
an elongate rigid member having a proximal end, a distal end, a handgrip at the distal end, and a hook-shaped release lever engaging tang at the proximal end;
an elongated release lever tensioner bar having a handle at a first end, an opposing free end, and an L-shaped hook intermediate the first and second ends, the hook being adapted for engaging a side of a semitrailer adjacent a tandem axle assembly release handle;
a collar slidably disposed on the rigid member, the tensioner bar being attached to the collar and slidable therewith; and
a tension spring having a first end attached to the free end of the tensioner bar and a second end attached to the rigid member adjacent the proximal end.

2. The tandem trailer lock release mechanism according to claim 1, wherein the L-shaped hook of the release lever tensioner bar has substantially orthogonal components extending a distance approximately two inches normal to said rigid member and a distance approximately two inches parallel to said rigid member.

3. The tandem trailer lock release mechanism according to claim 1, wherein the hook-shaped release lever engaging tang extends a distance of approximately two inches from the rigid member.

4. The tandem trailer lock release mechanism according to claim 1, wherein the rigid member is approximately 32.5 inches long.

5. The tandem trailer lock release mechanism according to claim 1, wherein the handgrip is oval shaped.

6. The tandem trailer lock release mechanism according to claim 1, wherein the handle of the release lever tensioner bar is T-shaped.

7. The tandem trailer lock release mechanism according to claim 1, wherein the tensioning spring has an end-to-end length in a non-extended state of approximately one foot.

8. The tandem trailer lock release mechanism according to claim 7, wherein the tensioning spring has an initial tension of approximately thirty-two pounds and a force multiplier of approximately 13.5 lbs per inch of displacement.

9. The tandem trailer lock release mechanism according to claim 1, wherein said tensioner bar has a hole defined therein, said spring having an end inserted through the hole.

10. The tandem trailer lock release mechanism according to claim 1, said rigid member has a loop disposed adjacent the proximal end, said spring having an end inserted through the loop.

11. A tandem trailer lock release mechanism, comprising:
an elongated rigid rod having a handle and a hook disposed at opposite ends thereof, the hook being adapted for engaging a release lever of a tandem trailer lock; and
means for supporting the rod against a wall of the trailer with the hook engaging the release lever in order to apply hands-free tension to the release lever.

12. The tandem trailer lock release mechanism according to claim 11, wherein said means for supporting comprises:
a spring concentrically disposed around said rigid rod adjacent the hook;
a tension bar attached to a first end of the spring;
a collar slidably disposed on the rigid rod, the tension bar being attached to the collar;
means for gripping the tension bar; and
means for engaging the wall of the trailer.

13. The tandem trailer lock release mechanism according to claim 12, wherein said means for gripping comprises a crossbar disposed across an end of said tension bar in order to form a T-shaped handle.

14. The tandem trailer lock release mechanism according to claim 12, wherein said means for engaging comprises an inverted L-shaped engaging member extending from said tension bar, the engaging member having a leg extending towards said hook.

15. The tandem trailer lock release mechanism according to claim 12, further comprising a loop formed on said rigid rod adjacent said hook, said spring having a second end inserted through the loop.
